(19) United States
(12) Patent Application Publication
(10) Pub. No.: US 2026/0172671 A1
(43) Pub. Date: Jun. 18, 2026

(54) IMAGE CAPTURING APPARATUS THAT TURNS OFF DISPLAY UNIT BY TURN-OFF METHOD CORRESPONDING TO TURN-OFF FACTOR, CONTROL METHOD OF IMAGE CAPTURING APPARATUS, AND STORAGE MEDIUM

(71) Applicant: CANON KABUSHIKI KAISHA, Tokyo (JP)

(72) Inventor: MIKIKO ISHIWATARI, Tokyo (JP)

(21) Appl. No.: 19/407,250

(22) Filed: Dec. 3, 2025

(30) Foreign Application Priority Data
Dec. 13, 2024 (JP) 2024-219011

(51) Int. Cl. H04N 23/65; H04N 23/63

(52) U.S. Cl. CPC H04N 23/651; H04N 23/63

(57) ABSTRACT

An image capturing apparatus detects proximity of an object to a display unit; and controls the display unit based on a detection result. The image capturing apparatus, in a case where the proximity is no longer detected from a state in which the proximity is detected, turns off the display unit by using first turn-off processing in which first power is consumed after turn-off and a first time is required for re-lighting, and in a case where a user operation on the image capturing apparatus is not performed for a predetermined period, turns off the display unit by using second turn-off processing in which second power smaller than the first power is consumed after turn-off and a second time longer than the first time is required for re-lighting.

### BACKGROUND

### Field of the Technology

The present disclosure relates to an image capturing apparatus, a control method of the image capturing apparatus, and a storage medium.

### Description of the Related Art

A digital camera, which is an example of an image capturing apparatus, may temporarily turn off an EVF in order to suppress power consumption when switching a display destination from the EVF to a liquid crystal display unit by withdrawal of eye from a state in which the EVF is displayed by eye contact. When the user does not perform an operation for a predetermined time or more, the EVF may be temporarily turned off in order to suppress power consumption. At this time, in both cases, it is common to turn off the EVF by stopping power supply and to bring it into a complete terminated state. EVF is an abbreviation for Electronic View Finder.

International Publication No. 2019/008874 discloses an image capturing apparatus including two display units, command signal lines of the respective display units for transmitting commands to the display units, and a display data line common to the two display units for transmitting display data. International Publication No. 2019/008874 discloses that when one display unit is in a display state, the other display unit is brought into a black image display state.

When the EVF is temporarily turned off, there may be a case of turning off due to a turn-off factor that needs re-lighting immediately (e.g., in a case of turning off by withdrawal of eye, there is a possibility of being subjected to eye contact immediately again). On the other hand, there may be a case of turn-off by a turn-off factor that does not need re-lighting immediately and that should prioritize reduction in power consumption (e.g., no user operation for a certain period).

However, when the EVF is uniformly brought into the complete terminated state in the scene where the EVF is temporarily turned off as described above, it is necessary to perform the activation processing of the EVF from the beginning at the time of re-lighting of the EVF, and therefore it takes time for re-lighting of the EVF. On the other hand, when the EVF is uniformly brought into the black image display state as in International Publication No. 2019/008874, the power consumption always increases.

### SUMMARY

The present disclosure has been made in view of the above problems, and provides a technique for turning off a display unit of an image capturing apparatus by an appropriate turn-off method corresponding to a turn-off factor in a case where the display unit is temporarily turned off.

According to one aspect of the present disclosure, there is provided an image capturing apparatus comprising: one or more memories storing instructions; and one or more processors configured to execute the instructions to: detect proximity of an object to a display unit; and control the display unit based on a detection result, wherein the one or more processors further execute the instructions to: in a case where the proximity is no longer detected from a state in which the proximity is detected, turn off the display unit by using first turn-off processing in which first power is consumed after turn-off and a first time is required for re-lighting, and in a case where a user operation on the image capturing apparatus is not performed for a predetermined period, turn off the display unit by using second turn-off processing in which second power smaller than the first power is consumed after turn-off and a second time longer than the first time is required for re-lighting.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration example of a digital camera that is an image capturing apparatus according to one embodiment.

FIG. 2 is an external view of a digital camera that is an image capturing apparatus according to one embodiment.

FIG. 3 is a flowchart showing a flow of display unit turn-on processing according to one embodiment.

FIG. 4 is a flowchart showing a flow of EVF turn-on processing according to one embodiment.

FIG. 5 is a flowchart showing a flow of display destination switching processing according to one embodiment.

FIG. 6 is a flowchart showing a flow of display unit turn-off processing by a power saving timer according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the embodiments described below, a case where the image capturing apparatus is a digital camera will be described as an example.

### Configuration of Digital Camera

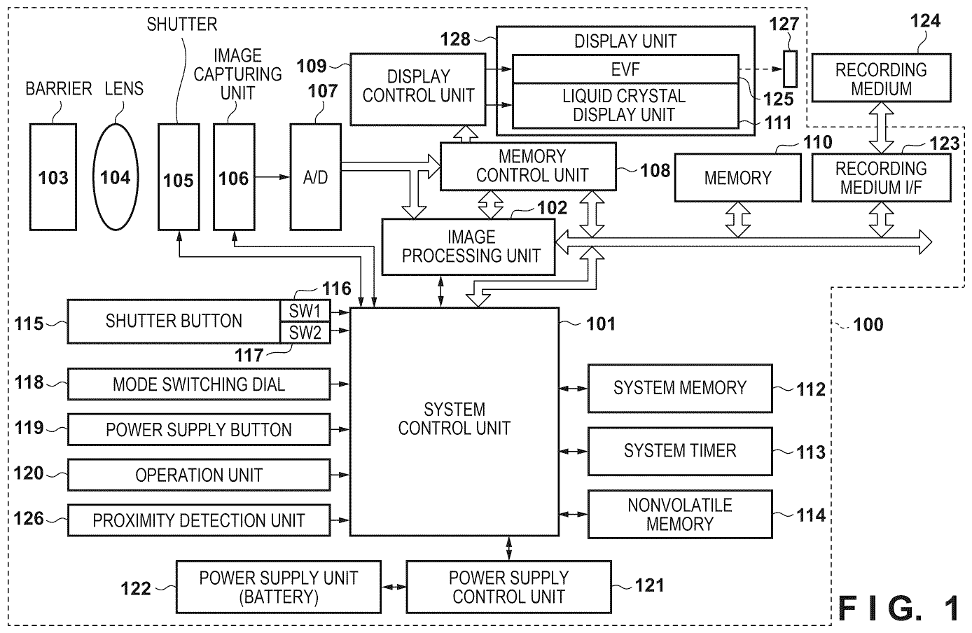

FIG. 1 is a block diagram illustrating a configuration example of a digital camera 100, which is an image capturing apparatus according to the present embodiment. FIG. 2 is an external view of the digital camera 100, which is an image capturing apparatus according to the present embodiment.

In FIG. 1, the digital camera 100 includes a system control unit 101, an image processing unit 102, a barrier 103, a photographic lens 104, a shutter 105, an image capturing unit 106, an A/D converter 107, a memory control unit 108, a display control unit 109, a memory 110, and a liquid crystal display unit 111. The digital camera 100 includes a system memory 112, a system timer 113, a nonvolatile memory 114, a shutter button 115, a first shutter switch 116, a second shutter switch 117, and a mode switching dial 118. The digital camera 100 includes a power supply button 119, an operation unit 120, a power supply control unit 121, a power supply unit 122, a recording medium I/F 123, a recording medium 124, an EVF 125, a proximity detection unit 126, an eyepiece unit 127, and display unit 128.

The liquid crystal display unit 111 is a rear monitor installed in a main body of the digital camera 100, for example. The EVF 125 is an electronic view finder provided in the eyepiece unit 127. The shooting lens 104 is a lens group including a zoom lens and a focus lens. The shutter 105 is a shutter having an aperture function. The image capturing unit 106 is an imaging element including a CCD, a CMOS element, or the like that converts an optical image into an electrical signal. By covering an image capturing system including the shooting lens 104 of the digital camera 100, the barrier 103 prevents contamination or damage of the image capturing system including the shooting lens 104, the shutter 105, and the image capturing unit 106.

The image processing unit 102 performs resizing processing such as predetermined pixel interpolation and reduction and color conversion processing on data acquired from the A/D converter 107 or data acquired from the memory control unit 108. The image processing unit 102 performs predetermined calculation processing using captured image data, and the system control unit 101 performs exposure control and distance measurement control based on a calculation result. Accordingly, through-the-lens (TTL) method auto focus (AF) processing, auto exposure (AE) processing, and flash pre-emission (EF) processing are performed. The image processing unit 102 further performs predetermined calculation processing using captured image data, and also performs TTL method auto white balance (AWB) processing based on the calculation result.

Output data from the A/D converter 107 is directly written into the memory 110 via the image processing unit 102 and the memory control unit 108 or via the memory control unit 108. The memory 110 stores image data obtained by the image capturing unit 106 and converted into digital data by the A/D converter 107, and image data to be displayed on the liquid crystal display unit 111 and the EVF 125. The memory 110 has a storage capacity sufficient to store a predetermined number of still images, a moving image of a predetermined time, and sound.

The memory 110 also serves as an image display memory (video memory), and the display control unit 109 converts image display data stored in the memory 110 into a display video signal and transmits the display video signal to the liquid crystal display unit 111 and the EVF 125 via a communication interface. Each of the liquid crystal display unit 111 and the EVF 125 is a display such as an LCD or an organic EL, and performs display corresponding to an analog signal from the display control unit 109. A digital signal having been A/D converted by the A/D converter 107 and accumulated in the memory 110 is converted into an analog signal in the display control unit 109, and is sequentially transferred to the liquid crystal display unit 111 or the EVF 125 and displayed, whereby live view (LV) display can be performed. Hereinafter, an image to be displayed through live view display will be referred to as a live view image (LV image). The liquid crystal display unit 111 and the EVF 125 are collectively referred to as the display unit 128.

Display signal communication between the display control unit 109 and the liquid crystal display unit 111 and the EVF 125 is performed using a digital high-speed serial communication interface such as MIPI, in which a display video signal and a black image signal are transmitted in HS/LP/ULPS modes as appropriate. In this display signal communication, not only the digital signal accumulated in the memory 110 but also the black image signal generated by the display control unit 109 can be transferred.

The proximity detection unit 126 is an eye contact detection sensor that detects (proximity detection) approach (eye contact) and separation (withdrawal of eye) of an eye (object) with respect to the eyepiece unit 127. The system control unit 101 switches between display (display state) and nondisplay (nondisplay state) of the liquid crystal display unit 111 and the EVF 125 depending on the state detected by the proximity detection unit 126. More specifically, at least in a shooting standby state and in a case where the switching setting of the display destination is automatic switching, the display control unit 109 turns on (displays) the liquid crystal display unit 111 with the liquid crystal display unit 111 as the display destination and turns off (does not display) the EVF 125 during non eye contact. During eye contact, the EVF 125 is turned on (displayed) with the EVF 125 as the display destination, and the liquid crystal display unit 111 is turned off (not displayed).

For example, an infrared proximity sensor can be used as the proximity detection unit 126, and approach of some object to the eyepiece unit 127 incorporating the EVF 125 can be detected. In a case where an object approaches, infrared light projected from a light projecting unit (not illustrated) of the proximity detection unit 126 is reflected by the object and received by a light receiving unit (not illustrated) of the infrared proximity sensor. The distance to which the object is approaching from the eyepiece unit 127 (eye contact distance) can also be determined by the amount of received infrared light.

In this manner, the proximity detection unit 126 performs eye contact detection of detecting the proximity distance of the object to the eyepiece unit 127 (EVF 125 in the eyepiece unit). Eye contact is detected in a case where an object approaching within a predetermined distance with respect to the eyepiece unit 127 (EVF 125 in the eyepiece unit) is detected from a non eye contact state (non-proximity state). Withdrawal of eye is detected in a case where an object whose approach has been detected is separated by more than a predetermined distance from the eye contact state (proximity state). A threshold for detecting eye contact and a threshold for detecting withdrawal of eye may be different from each other, for example, by providing hysteresis or the like. It is assumed that after eye contact is detected, it is in the eye contact state until withdrawal of eye is detected. It is assumed that after withdrawal of eye is detected, it is in the non eye contact state until eye contact is detected. The infrared proximity sensor is an example, and another sensor may be adopted as the proximity detection unit 126 as long as it can detect a state that can be regarded as eye contact.

During display of the liquid crystal display unit 111 or the EVF 125, in a predetermined period designated by the user, it is detected using the system timer 113 that no user operation has been performed on the shutter button 115 described later, the mode switching dial 118, the power supply button 119, and the operation unit 120. In a case where it is detected that no user operation has been performed, the display control unit 109 turns off the liquid crystal display unit 111 or the EVF 125 currently being displayed. In a case where a user operation is performed on the shutter button 115, the mode switching dial 118, the power supply button 119, the operation unit 120, or the like in a state in which the liquid crystal display unit 111 or the EVF 125 is turned off, the system control unit 101 detects the user operation. The system control unit 101 instructs the display control unit 109 to perform re-lighting of the liquid crystal display unit 111 or the EVF 125. It is possible to return to the display state by the display control unit 109 performing the turn-on processing of the liquid crystal display unit 111 or the EVF 125 again.

The nonvolatile memory 114 is an electrically erasable/recordable memory, and for example, an EEPROM or the like is used. The nonvolatile memory 114 stores constants, programs, and the like for operation of the system control unit 101. The programs mentioned here are programs for executing various flowcharts described later in the present embodiment.

The system control unit 101 controls the entire operation of the digital camera 100. Processing of the present embodiment described later is implemented by reading and executing the programs recorded in the nonvolatile memory 114 described above. A RAM is used as the system memory 112. In the system memory 112, constants and variables for operation of the system control unit 101, a program read from the nonvolatile memory 114, and the like are deployed. The system timer 113 is a clocking unit that measures a time used for various types of control and a time of a built-in clock.

The shutter button 115, the mode switching dial 118, the power supply button 119, and the operation unit 120 input various operation instructions to the system control unit 101.

The mode switching dial 118 is a dial for switching an operation mode of the system control unit 101 to operation modes such as a still image recording mode and a moving image recording mode.

The first shutter switch 116 is turned on by a midway of operation of the shutter button 115 provided in the digital camera 100, i.e., what is called half-press (shooting preparation instruction), and generates a first shutter switch signal SW1. By the first shutter switch signal SW1, the system control unit 101 starts operations such as the auto focus (AF) processing, the auto exposure (AE) processing, the auto white balance (AWB) processing, and the flash pre-emission (EF) processing.

The second shutter switch 117 is turned on by operation completion of the shutter button 115, i.e., what is called full-press (shooting instruction), and generates a second shutter switch signal SW2. By the second shutter switch signal SW2, the system control unit 101 starts a series of shooting processing operations from reading of a signal from the image capturing unit 106 to writing of image data into the recording medium 124.

The power supply control unit 121 includes a battery detection circuit, a DC-DC converter, and a switch circuit that switches a block to be energized, and detects the state of the power supply button 119, whether or not a battery is attached, the type of the battery, and a battery remaining amount. The power supply control unit 121 controls the DC-DC converter based on the detection result and an instruction of the system control unit 101, and supplies a necessary voltage to units including the recording medium 124 for a necessary period.

The power supply unit 122 includes a primary battery such as an alkaline battery or a lithium battery, a secondary battery such as an NiCd battery, an NiMH battery, or an Li battery, and an AC adapter. In the present embodiment, a case where a secondary battery is used for the power supply unit 122 (hereinafter called a battery) will be described. A battery 122 and the recording medium 124 can be inserted from a bottom surface of the digital camera 100, and can be covered with an openable cover (not illustrated).

The recording medium I/F 123 is an interface with the recording medium 124 such as a memory card or a hard disk. The recording medium 124 is a recording medium such as a memory card for recording a shot image, and includes a semiconductor memory and a magnetic disk.

The operation unit 120 is one or more operation members for inputting various operation instructions to the system control unit 101. As illustrated in FIG. 2, the operation unit 120 includes a menu button 201, a cross button 202, a SET button 203, and a playback button 204.

For example, when the menu button 201 is pressed, a menu screen that enables various settings is displayed on the liquid crystal display unit 111 or the EVF 125. The user can intuitively perform various settings using the menu screen displayed on the liquid crystal display unit 111 or the EVF 125 and the cross button 202 including buttons in four directions of up, down, left, and right or the SET button 203.

The playback button 204 is an operation button for switching between a shooting mode and a playback mode. When the playback button 204 is pressed during the shooting mode, the mode transitions to the playback mode, and the latest image among the images recorded in the recording medium 124 can be displayed on the liquid crystal display unit 111 or the EVF 125.

Also in a case where the display destination is switched by detection of eye contact/withdrawal of eye of the proximity detection unit 126 during menu display or playback mode display, the menu display and the playback mode display are each continued.

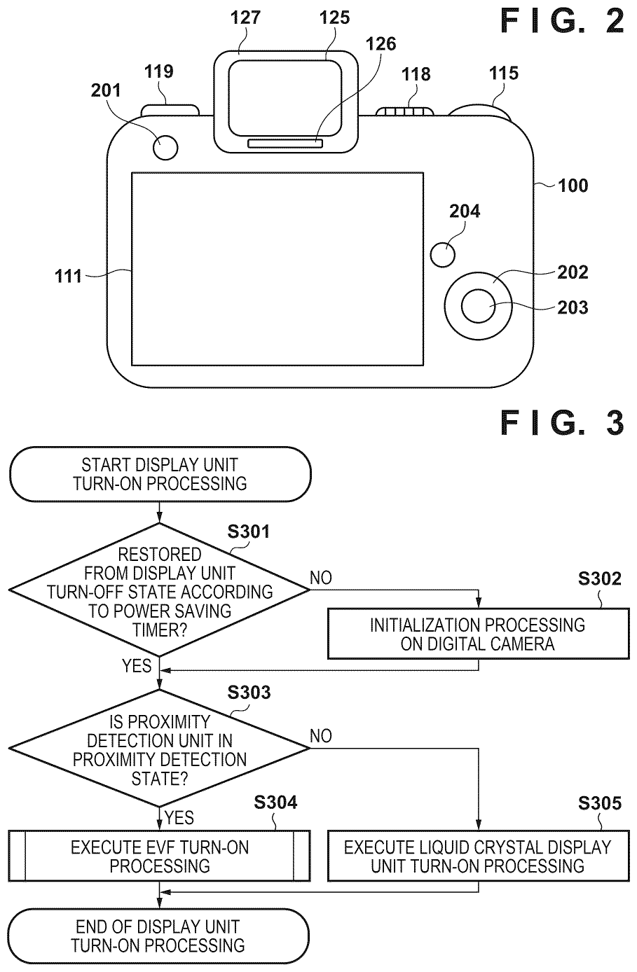

Next, a flow of processing when the digital camera 100 according to the present embodiment temporarily turns off the EVF 125 will be described with reference to the flowcharts in FIGS. 3 to 6. A function of detecting a state in which no user operation on the shutter button 115, the mode switching dial 118, the power supply button 119, or the operation unit 120 has been performed on the digital camera 100 for a predetermined period designated by the user using the system timer 113 is called a power saving timer function.

### Display Unit Turn-On Processing

First, with reference to the flowchart of FIG. 3, a flow of processing for turning on the display unit 128 in response to an operation on an operation member such as the power supply button 119 by the user when the digital camera 100 according to the present embodiment is in a power supply off state or an auto power off state will be described. The processing of each of the flowcharts according to the present embodiment is implemented by the digital camera 100 operating as a computer (CPU) reading and executing a program stored in the memory.

In S301, the system control unit 101 determines whether or not turn-on processing is restoring processing from a turn-off state of the display unit 128 by the power saving timer function. In a case where the turn-on processing is determined to be the restoring processing, the processing proceeds to S303. On the other hand, in a case where the turn-on processing is determined not to be the restoring processing, the processing proceeds to S302. A specific pattern of not proceeding to S302 but proceeding to S303 will be described later in a fourth embodiment.

In S302, the system control unit 101 executes initialization processing of the digital camera 100. With the activation of each control unit and device, measurement of the system timer 113 is started and monitoring of a proximity state of the eyepiece unit 127 in the proximity detection unit 126 is started. Thereafter, the processing proceeds to S303.

In S303, the system control unit 101 determines whether or not the proximity detection unit 126 is in a proximity detection state based on a detection result of the proximity detection unit 126. In a case where it is determined that the proximity detection unit 126 is in the proximity detection state, the processing proceeds to S304. On the other hand, in a case where it is determined that the proximity detection unit 126 is not in the proximity detection state, the processing proceeds to S305.

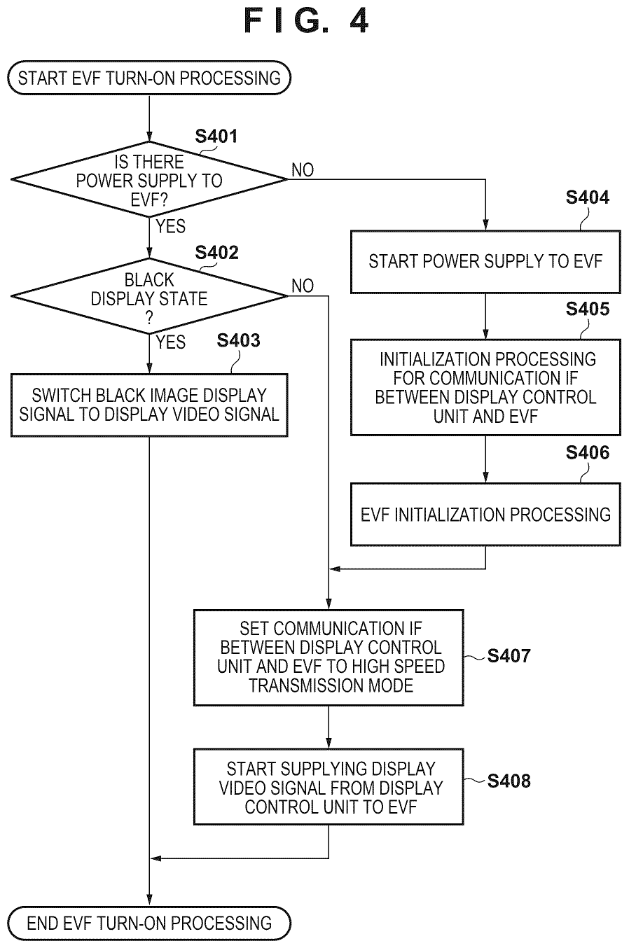

In S304, the display control unit 109 executes the turn-on processing of the EVF 125. Accordingly, the turn-on processing of the display unit 128 (EVF 125) is completed. The turn-on processing of the EVF 125 in S304 will be described later in detail with reference to FIG. 4. The liquid crystal display unit 111 is turned off. At that time, the power supply to the liquid crystal display unit 111 is stopped without bringing it into a black display state, and the display is completely turned off. For example, there is a low possibility for the user to bother to withdraw an eye from a state of looking into the EVF 125 to perform shooting, and switching to the display of the liquid crystal display unit 111 to perform shooting, and therefore processing of prioritizing the suppression of power consumption is performed.

In S305, the display control unit 109 executes turn-on processing of the liquid crystal display unit 111. Accordingly, the turn-on processing of the display unit 128 (liquid crystal display unit 111) is completed. The above is the series of processing in FIG. 3.

### EVF Turn-On Processing

Next, the turn-on processing of the EVF 125 in S304 will be described in detail with reference to the flowchart in FIG. 4.

In S401, the system control unit 101 determines whether or not the power is supplied to the EVF 125. In a case where it is determined that the power is supplied to the EVF 125, the processing proceeds to S402. On the other hand, in a case where it is determined that the power is not supplied to the EVF 125, the processing proceeds to S404. For example, in a case where the digital camera 100 is in the power supply off state or the auto power off state, and the digital camera 100 is activated by the operation member such as the power supply button 119 by the user, power supply to the EVF 125 is not started. Therefore, it is determined that there is no power supply to the EVF 125.

In S402, the display control unit 109 determines whether or not the EVF 125 is in a black display state. Here, the black display state can include a state in which a black image is displayed receiving supply of a black image signal or a state in which supply of a display video signal is stopped. In a case where it is determined that the EVF 125 is in the black display state, the processing proceeds to S403. On the other hand, in a case where it is determined that the EVF 125 is not in the black display state, the processing proceeds to S407.

In S403, the display control unit 109 switches, to a display video signal, the black image signal supplied from the display control unit 109 to the EVF 125. Accordingly, re-lighting of the EVF 125 is completed. In S404, the system control unit 101 starts power supply to the EVF 125.

In S405, the display control unit 109 executes initialization processing of a communication interface (IF) between the display control unit 109 and the EVF 125. The display control unit 109 also performs start of supply of a communication clock of the communication IF between the display control unit 109 and the EVF 125, and setting of a low power (LP) mode (command transmission mode) of the communication IF.

In S406, the display control unit 109 performs device initialization processing of the EVF 125. Specifically, device initialization of the EVF 125 is performed by transmitting, to the EVF 125, an initialization command for initializing the EVF 125 using the communication IF initialized in S405.

In S407, the display control unit 109 sets the communication IF between the display control unit 109 and the EVF 125 to a high speed transmission (HS) mode. Accordingly, the display video signal can be transmitted from the display control unit 109 to the EVF 125.

In S408, the display control unit 109 transmits the display video signal from the display control unit 109 to the EVF 125. Accordingly, the turn-on processing of the EVF 125 is completed, and the EVF 125 is brought into the display state. The above is the series of processing in FIG. 4.

### Display Destination Switching Processing

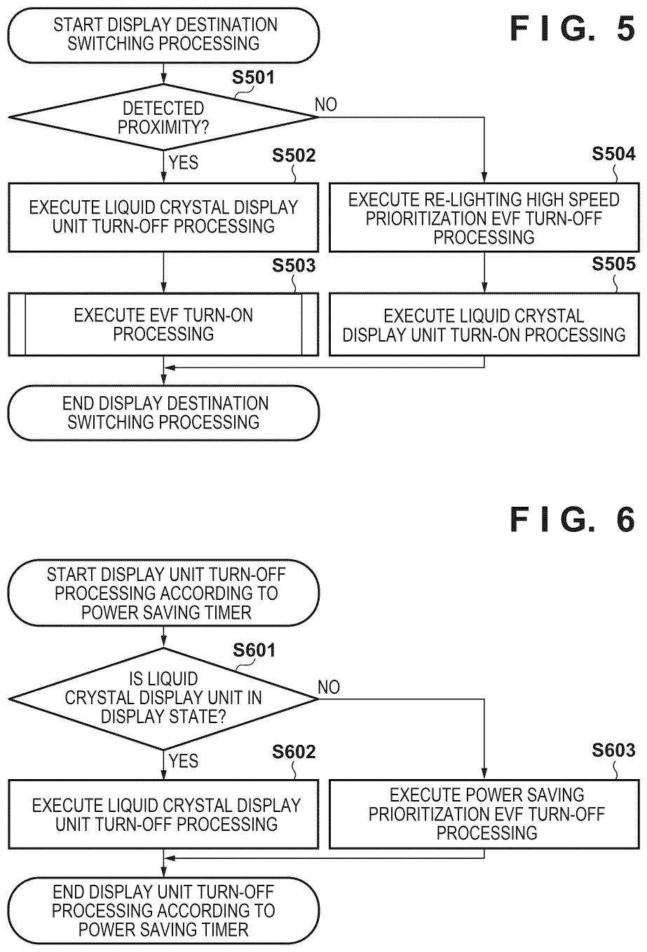

Next, display destination switching processing (including temporary turn-off processing of the EVF 125) in a case where the proximity detection unit 126 detects a change in a proximity state while the display unit 128 (EVF 125) is in a turn-on state after the processing of FIG. 3 is executed will be described with reference to the flowchart of FIG. 5. When the proximity detection unit 126 detects a change in the proximity state, the processing of FIG. 5 starts.

In S501, the system control unit 101 determines whether or not the proximity detection unit 126 has detected proximity (eye contact). In a case where it is determined that the proximity detection unit 126 has detected the proximity, the processing proceeds to S502 in order to switch the display destination from the liquid crystal display unit 111 to the EVF 125. On the other hand, in a case where it is determined that the proximity detection unit 126 has not detected the proximity (withdrawal of eye), the processing proceeds to S504 in order to switch the display destination from the EVF 125 to the liquid crystal display unit 111. The switching of the display destination is processing of turning off the EVF 125 and displaying, on the liquid crystal display unit 111, the display content of the EVF 125 before turn-off, or processing of turning off the liquid crystal display unit 111 to display, on the EVF 125, the display content of the liquid crystal display unit 111 before turn-off.

In S502, the display control unit 109 turns off the liquid crystal display unit 111. In S503, the display control unit 109 executes turn-on processing of the EVF 125. The content of the processing of S503 changes depending on whether the EVF turn-off processing of S504 has been executed once by withdrawal of eye before the processing of S503 is executed. The processing of S503 of a case of having been executed will be described later together with details of the processing of S504 in a second embodiment and a third embodiment. The processing of S503 of a case of having not been executed (turn-off of the EVF 125 by withdrawal of eye is never performed) is the same processing as the processing (S404 to S408) performed in S304. In FIG. 5, the processing of S503 is performed after the processing of S502, but these two may be performed in parallel.

In S504, the display control unit 109 executes EVF turn-off processing that is large in power consumption but short in the time required for re-lighting of the EVF 125. Here, the reason why the processing of S504 is executed as the turn-off processing of the EVF 125 will be described. In a case where the user performs eye contact again from a state in which the EVF 125 is turned off by withdrawal of eye, the proximity detection unit 126 performs proximity detection, and the display control unit 109 switches the display destination to the EVF 125 again. In this case, it is recommended that re-lighting of the EVF 125 be fast so that the user does not miss the shooting opportunity, and therefore the processing of S504 is executed for the purpose of speeding up re-lighting of the EVF 125. Details of the processing of S504 will be described later together with re-lighting processing of the EVF 125 in the second embodiment and the third embodiment.

In S505, the display control unit 109 executes the turn-on processing of the liquid crystal display unit 111. The above is the series of processing in FIG. 5. In FIG. 5, the processing of S505 is performed after the processing of S504, but these two may be performed in parallel.

### Display Unit Turn-Off Processing Using Power Saving Timer Function

Next, processing in a case where the display unit 128 is temporarily turned off by the power saving timer function after the processing of FIG. 3 is executed will be described with reference to the flowchart of FIG. 6.

In S601, the display control unit 109 determines whether or not the liquid crystal display unit 111 is in a display state. In a case where it is determined that the liquid crystal display unit 111 is in the display state, the processing proceeds to S602. On the other hand, in a case where it is determined that the liquid crystal display unit 111 is not in the display state, the processing proceeds to S603.

In S602, the display control unit 109 executes turn-off processing of the liquid crystal display unit 111. In S603, the display control unit 109 performs EVF turn-off processing that requires a long time for re-lighting of the EVF 125 but is small in power consumption. Details of the processing of S603 will be described later together with the re-lighting processing of the EVF 125 in the fourth embodiment.

In a case where the EVF 125 is turned off by the power saving timer function, re-lighting of the EVF 125 can be performed by performing a user operation on the shutter button 115, the mode switching dial 118, the power supply button 119, the operation unit 120, or the like in a state in which the proximity detection unit 126 detects proximity after turn-off. On the other hand, since there is a low possibility for the user to immediately perform shooting after re-lighting, the processing of S603 is executed for the purpose of suppressing power consumption.

As described above, in the present embodiment, in a scene where the EVF 125 is temporarily turned off, the turn-off processing of the EVF 125 is switched corresponding to a turn-off factor. Specifically, EVF turn-off processing of prioritizing high-speed execution of re-lighting is executed in a case of turn-off by withdrawal of eye, and EVF turn-off processing of prioritizing power saving is executed in a case of turn-off by the power saving timer function.

In other words, in a case where proximity is no longer detected from a state in which proximity is detected, the EVF 125 is turned off using turn-off processing in which relatively large power is consumed after turn-off and a relatively short time is required for re-lighting. In a case where a user operation on the digital camera 100 is not performed for a predetermined period, the EVF 125 is turned off using turning-off processing in which relatively small power is consumed after turn-off and a relatively long time is required for re-lighting.

Accordingly, in a case where it is recommended that re-lighting of the EVF 125 be fast, the re-lighting can be speeded up, and otherwise, the power consumption can be suppressed. Therefore, in a case of temporarily turning off the display unit (EVF 125) of the image capturing apparatus (digital camera 100), it is possible to turn off the display unit by an appropriate turn-off method corresponding to a turn-off factor.

### Second Embodiment

In the present embodiment, details of the turn-off processing of S504 of FIG. 5 will be described. In S504, the display control unit 109 switches, to a black image signal to be generated by display control unit 109, the display video signal supplied from the display control unit 109 to the EVF 125. Accordingly, since a black image is displayed on the EVF 125, the appearance to the user is the same as the appearance when the EVF 125 is completely turned off. At this time, the power supply to the EVF 125 is in a supply state, and the black image signal is continuously supplied from the display control unit 109 to the EVF 125, and therefore the power consumption of the digital camera 100 increases.

The EVF 125 is turned on again from the state of being temporarily turned off previously in S504 when the processing of FIG. 5 is executed again, proximity is detected in S501, and the processing of S503 is executed. The processing at this time will be described with reference to FIG. 4.

In this case, the system control unit 101 determines in S401 that there is power supply to the EVF 125, and therefore the processing proceeds to S402. Then, in S402, the display control unit 109 determines that the display state is the black display state, and therefore the processing proceeds to S403. In S403, the display control unit 109 switches, to the display video signal, the black image signal supplied from the display control unit 109 to the EVF 125. Accordingly, re-lighting of the EVF 125 is completed. In this case, although the power consumption is large, the time required for re-lighting of the EVF 125 is shorter than that in the processing of S603 described later in the fourth embodiment.

In the turn-off processing of the EVF 125 described in the present embodiment, in a case where the EVF 125 is not an organic EL but a display member having a backlight such as an LCD, the backlight may be further turned off.

As described above, in a case where the EVF 125 is turned off in the processing of S504 described in the present embodiment, the power consumption is larger than that in a case where the EVF 125 is turned off in the processing of S603 described later in the fourth embodiment. On the other hand, the time required for re-lighting of the EVF 125 is shorter than that in the case where the EVF 125 is turned off in the processing of S603 described later in the fourth embodiment.

### Third Embodiment

In the second embodiment, an example in which the display video signal supplied from the display control unit 109 to the EVF 125 is switched to the black image signal to be generated by display control unit 109 is described regarding the processing of S504, but the present embodiment is not limited to this example, and the following processing according to the present embodiment may be performed.

In S504, first, the display control unit 109 stops supply of the display video signal from the display control unit 109 to the EVF 125. Accordingly, since the display video signal is no longer output to the EVF 125, the display state is brought into the black display state, and the turn-off processing of S504 can be executed. The display control unit 109 sets the communication IF between the display control unit 109 and the EVF 125 from the high speed transmission (HS) mode to the low power (LP) mode. Then, an ultra-low power state (ULPS) mode is further set from the low power mode.

At this point, the power is supplied to the EVF 125, but the display video signal is not supplied from the display control unit 109 to the EVF 125, and the communication IF is also in a state (ULPS) in which the power consumption is small. Therefore, the power consumption of the digital camera 100 is smaller than that in the processing of S504 described in the second embodiment.

A trigger (factor) for re-lighting of the EVF 125 regarding the processing when the EVF 125 is turned on again from the temporarily turned-off state is the same as that in the first embodiment in a case of executing the processing of S504 described above. Hereinafter, details of the processing of FIG. 4 according to the present embodiment will be described.

In this case, the system control unit 101 determines in S401 that there is power supply to the EVF 125, and therefore the processing proceeds to S402. Then, in S402, since the display control unit 109 determines that the display state is not the black display state, the processing proceeds to S407. In S407, the display control unit 109 sets the communication IF between the display control unit 109 and the EVF 125 from the ultra-low power state (ULPS) mode to the low power (LP) mode, and from the low power (LP) mode to the high speed transmission (HS) mode. Accordingly, the display video signal can be transmitted from the display control unit 109 to the EVF 125. Thereafter, the processing proceeds to S408. In S408, the display control unit 109 sends the display video signal from the display control unit 109 to the EVF 125. Accordingly, the turn-on processing of the EVF 125 is completed, and the EVF 125 is brought into the display state.

As described above, in a case where the EVF 125 is turned off in the processing of S504 described in the present embodiment, the time required for re-lighting of the EVF 125 becomes longer than that in the case where the EVF 125 is turned off in the processing of S504 described in the second embodiment. On the other hand, the power consumption becomes smaller than that in the case where the EVF 125 is turned off in the processing of S504 described in the second embodiment.

### Fourth Embodiment

In the present embodiment, details of the processing of S603 of FIG. 6 will be described. In S603, first, the display control unit 109 stops supply of the display video signal from the display control unit 109 to the EVF 125. Next, the display control unit 109 sets the communication IF between the display control unit 109 and the EVF 125 from the high speed transmission (HS) mode to the low power (LP) mode, stops the supply of the communication clock, and executes termination processing of the communication IF. Finally, the power supply to the EVF 125 is stopped. Accordingly, the processing of S603 is completed. According to the processing of S603, the EVF 125 is brought into a state of not being supplied with the power, and therefore the power consumption of the digital camera 100 can be suppressed.

The EVF 125 is turned on again from a temporarily turned-off state in S603 when a user operation is performed on the shutter button 115, the mode switching dial 118, the power supply button 119, and the operation unit 120 in the eye contact state. The processing at this time will be described with reference to FIGS. 3 and 4.

First, in S301, the system control unit 101 determines that the turn-on processing is restoring processing from the turn-off state of the display unit 128 by the power saving timer function, and therefore the processing proceeds to S303. In S303, the system control unit 101 determines that the proximity detection unit 126 is in the proximity detection state, and therefore the processing proceeds to S304. In S304, the display control unit 109 executes the turn-on processing of the EVF 125. Here, as the detailed processing of S304, the processing of FIG. 4 is executed. Since the power supply to the EVF 125 is stopped in the processing of S603 described above, the system control unit 101 determines in S401 that the power is not supplied to the EVF 125, and the processing proceeds to S404. Thereafter, the processing of S404 to S408 is executed similarly to the time of activation of the digital camera 100 described in the first embodiment.

As described above, in a case where the EVF 125 is turned off in the processing of S603 described in the present embodiment, the time required for re-lighting of the EVF 125 becomes longer than that in the case where the EVF 125 is turned off in the processing of S504 described in the second embodiment and the third embodiment. On the other hand, the power consumption becomes smaller than that in the case where the EVF 125 is turned off in the processing of S504 described in the second embodiment and the third embodiment.

### Fifth Embodiment

When a screen on which the user cannot immediately perform shooting is displayed on the EVF 125, the processing of S603 with small power consumption may be executed even in a case where the EVF 125 is temporarily turned off by withdrawal of eye. Here, the case where a screen on which the user cannot immediately perform shooting is displayed on the EVF 125 can include a case where the menu screen is displayed on the EVF 125 in response to pressing of the menu button 201 by the user. Alternatively, the case where a screen on which the user cannot immediately perform shooting is displayed on the EVF 125 can include a case where the playback screen is displayed on the EVF 125 in response to pressing of the playback button 204.

In a case of such screen display, the processing of S603 may be executed with priority given to suppressing of the power consumption for a reason that the display of the menu screen or the playback screen is continued even at the time of re-lighting of the EVF 125, which is not a state in which the user can immediately perform shooting.

Which of the processing of S504 and the processing of S603 to execute as turn-off processing of the EVF 125 may be configured to be selectable by the user in a case where the display of the EVF 125 is the menu screen or the playback screen. For example, a selection menu may be displayed, and a reception display screen for receiving user selection in advance may be displayed. After the reception is completed, the processing selected by the user is set to be executed.

As described above, according to the present embodiment, when the EVF 125 is temporarily turned off by withdrawal of eye in a state in which the menu screen or the like is displayed on the EVF 125, the time required for re-lighting of the EVF 125 in the case of executing S603 becomes longer than that in the case of executing S504. On the other hand, in the case of executing S603, the power consumption can be made smaller than that in the case of executing S504.

According to the present disclosure, it is possible to turn off a display unit of an image capturing apparatus by an appropriate turn-off method corresponding to a turn-off factor in a case where the display unit is temporarily turned off.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-219011, filed Dec. 13, 2024 which is hereby incorporated by reference herein in its entirety.

What is claimed is:

1. An image capturing apparatus comprising:
one or more memories storing instructions; and
one or more processors configured to execute the instructions to:
detect proximity of an object to a display unit; and
control the display unit based on a detection result,
wherein the one or more processors further execute the instructions to:
in a case where the proximity is no longer detected from a state in which the proximity is detected, turn off the display unit by using first turn-off processing in which first power is consumed after turn-off and a first time is required for re-lighting, and
in a case where a user operation on the image capturing apparatus is not performed for a predetermined period, turn off the display unit by using second turn-off processing in which second power smaller than the first power is consumed after turn-off and a second time longer than the first time is required for re-lighting.

2. The image capturing apparatus according to claim 1,
wherein the one or more processors further execute the instructions to:
control a second display unit different from the display unit based on the detection result.

3. The image capturing apparatus according to claim 2,
wherein the one or more processors further execute the instructions to:
in a case where the proximity is detected, turn off the second display unit and turn on the display unit.

4. The image capturing apparatus according to claim 3,
wherein the one or more processors further execute the instructions to:
display, on the display unit, display content of the second display unit before turn-off.

5. The image capturing apparatus according to claim 2,
wherein the one or more processors further execute the instructions to:
further turn off the second display unit in a case where a user operation on the image capturing apparatus is not performed for a predetermined period.

6. The image capturing apparatus according to claim 2,
wherein the one or more processors further execute the instructions to:
in a case where the proximity is no longer detected from a state in which the proximity is detected, turn off the display unit by using the first turn-off processing and turn on the second display unit.

7. The image capturing apparatus according to claim 6,
wherein the one or more processors further execute the instructions to:
display, on the second display unit, display content of the display unit before turn-off.

8. The image capturing apparatus according to claim 2,
wherein the display unit is an electronic view finder (EVF) in an eyepiece unit of the image capturing apparatus, and
the second display unit is a rear monitor installed in a main body of the image capturing apparatus.

9. The image capturing apparatus according to claim 1, wherein the first turn-off processing is turn-off processing of bringing the display unit into a black display state without stopping power supply to the display unit.

10. The image capturing apparatus according to claim 9, wherein the first turn-off processing is to bring the display unit into a black display state by switching a display video signal supplied to the display unit to a generated black image signal.

11. The image capturing apparatus according to claim 9, wherein the first turn-off processing is to bring the display unit into a black display state by stopping supply of a display video signal to the display unit.

12. The image capturing apparatus according to claim 1, wherein the second turn-off processing includes processing of stopping power supply to the display unit.

13. The image capturing apparatus according to claim 1,
wherein the one or more processors further execute the instructions to:
turn off the display unit by using the second turn-off processing in a case where the display unit is displaying a menu screen or a playback screen when the proximity is no longer detected from a state in which the proximity is detected.

14. The image capturing apparatus according to claim 1,
wherein the one or more processors further execute the instructions to:
receive, from a user, selection as to which of the first turn-off processing or the second turn-off processing to use to turn off the display unit in a case where the display unit is displaying a menu screen or a playback screen when the proximity is no longer detected from a state in which the proximity is detected.

15. A control method of an image capturing apparatus, the control method comprising:
detecting proximity of an object to a display unit; and
controlling the display unit based on a detection result in the detecting,
wherein in the controlling,
in a case where the proximity is no longer detected from a state in which the proximity is detected, the display unit is turned off by using first turn-off processing in which first power is consumed after turn-off and a first time is required for re-lighting, and
in a case where a user operation on the image capturing apparatus is not performed for a predetermined period, the display unit is turned off by using second turn-off processing in which second power smaller than the first power is consumed after turn-off and a second time longer than the first time is required for re-lighting.

16. A non-transitory computer-readable storage medium storing a program for causing a computer to execute a control method of an image capturing apparatus, the control method including:
detecting proximity of an object to a display unit; and
controlling the display unit based on a detection result in the detecting,
wherein in the controlling,
in a case where the proximity is no longer detected from a state in which the proximity is detected, the display unit is turned off by using first turn-off processing in which first power is consumed after turn-off and a first time is required for re-lighting, and
in a case where a user operation on the image capturing apparatus is not performed for a predetermined period, the display unit is turned off by using second turn-off processing in which second power smaller than the first power is consumed after turn-off and a second time longer than the first time is required for re-lighting.
